(19) United States
(12) Patent Application Publication
(10) Pub. No.: US 2007/0277547 A1
(43) Pub. Date: Dec. 6, 2007

(54) Beverage cooling and dispensing unit

(76) Inventors: Asoka Veeravagu, Boynton Beach, FL (US); Patricia Bassett, Boca Raton, FL (US); Phetsouvanh Kounlavong, Boynton Beach, FL (US)

Correspondence Address: Lawrence J. Shurupoff;Sunbeam Products, Inc., 2381 Executive Center Drive, Boca Raton, FL, 33431, US

(21) Appl. No.: 11/445,627

(22) Filed: Jun. 1, 2006

(51) Int. Cl. B67D 5/62; F25D 3/08

(52) U.S. Cl. 62/396; 62/457.3; 62/457.5; 62/397; 222/146.6

(57) ABSTRACT

A beverage and cooling dispensing apparatus for holding both containerized and non-containerized beverages including a cooler unit adaptable for holding and cooling containerized products such as bottled and canned beverages and other chilled products, an internal container adaptable for holding non-containerized free-standing beverages which is positionable within the main cooler unit, and a dispensing mechanism accessible from the exterior of the cooler unit for dispensing the non-containerized beverage from the internal container. The internal container includes a first coupling mechanism which is engageable with a second coupling mechanism associated with the dispensing mechanism for providing fluid communication between the dispensing mechanism and the internal container when the first and second coupling mechanisms are engaged.

### BACKGROUND OF THE INVENTION

The present invention relates generally to beverage cooling and dispensing devices and, more particularly, to a cooler unit which includes an internal container for storing, cooling, and dispensing a non-containerized, free-flowing beverage while also storing and cooling additional items such as containerized beverages, food items, and the like.

Beverage coolers are a very popular consumer item, especially during the summer months. People enjoy parties, barbeques, tail-gate parties, picnics and many other gatherings where they typically bring their own beverages and/or food. Such coolers are used to store and cool canned or bottled beverages and food items, usually using ice to cool the interior of the cooler. Typically the cooler is a simple, single container with insulated walls and a lid so as to hold the coolness or cooling effect of the ice within the container. However, such coolers can only store containerized beverages, not a free-flowing or free-standing non-containerized beverage.

In addition to containerized beverages in bottles and cans, people enjoy creating their own beverages or mixed drinks/cocktails and taking them to parties and/or family gatherings. Margaritas, bloody marys, tea, juices and lemonade, for example, are very popular beverages that people prefer freshly prepared, as opposed to a canned or bottled pre-made beverage. However, prior art beverage coolers are not designed to contain these types of free-standing non-containerized beverages. Instead, people will put the free-flowing beverage in another specialized container for holding such beverages, such as a sealed pitcher, a water-type jug, or some other insulated type thermos or fluid holding container. Often times, this specialized container will be placed in a conventional cooler for cooling. When a user wants to pour the free-standing beverage contained in the pitcher or other specialized container, the user must first remove this additional container from the cooler, remove the sealed lid from the pitcher or otherwise access and activate a spigot or spout and then pour the non-containerized beverage into a cup. This can be time consuming. Also, every time the conventional cooler is opened and the additional container is removed, more heat is introduced both to the additional container and to the interior of the cooler, thus warming both the beverage and the cooler. This is an undesirable consequence of the current method for chilling such fee-standing non-containerized beverages.

Other solutions to this problem require the user to transport or mix the free-standing beverage at the party site and thereafter place ice directly in contact with the free-standing beverage in order to chill it. As the ice lowers the temperature of the beverage, it melts and dilutes the consistency of the beverage. The varying consistency of the free-standing beverage over time due to the melting ice is likewise an undesirable consequence.

There is therefore a need for a single cooler unit that can both store and cool containerized beverages and food items like the prior art coolers, and which can also store, cool, and easily dispense a free-flowing non-containerized beverage.

Accordingly, the present invention is directed to a beverage cooling and dispensing unit which overcomes one or more of the problems set forth above.

### SUMMARY OF THE INVENTION

The present invention overcomes many of the shortcomings and limitations discussed above and teaches the construction, operation and use of several embodiments of a beverage cooling and dispensing unit adaptable for holding and cooling both containerized and non- containerized beverages and for additionally dispensing the non-containerized free-standing beverage via means exterior of the unit. All embodiments of the present invention disclose a beverage cooling and dispensing unit which utilizes a separate internal container adaptable for containing a free-flowing or free-standing liquid such as a non-containerized beverage, which internal container is positionable within the main cooler unit. The present cooler unit is designed to contain and cool the internal container as well as additional items such as canned and bottled beverages, juice boxes, food items and the like. The internal container includes coupling means for interfacing with corresponding coupling means associated with a spout and tap mechanism for dispensing the free-standing beverage from the internal container. When the main cooler unit and the internal container are coupled together, the interior of the internal container is in fluid communication with the spout and tap mechanism located on the exterior of the cooling unit. A user can easily dispense the free-flowing beverage via the spout and tap mechanism. In addition to easily dispensing the free-flowing beverage housed within the internal container, a user can open the cooler unit and access cooled containerized beverages such as canned or bottled beverages, food items, or other chilled products.

The internal container includes an input fill tube with removable cap, a removable lid member, and a spring loaded output check valve associated with its coupling means. The internal container can be filled at a location remote from the main cooler unit and can be transported to the main cooler unit without the beverage leaking from the internal container. Alternatively, once the internal container is coupled to the main cooler unit, the input fill tube can be used to replenish the free-standing beverage without removing the internal container from the main cooler unit.

The internal container interfaces with the dispensing spout and tap mechanism via the spring loaded output check valve that prevents liquid from flowing out of the internal container unless the internal container is properly positioned within the main cooler unit. The spout and tap are located external to the main cooler housing and are easily accessible by a user to dispense the contents of the internal container into a cup, glass or other drinking vessel. Constant flow rate from the dispensing spout is maintained by venting means on the cap of the fill tube which prevents a vacuum from developing within the internal container.

The different embodiments of the present invention disclosed herein vary primarily with respect to the size and shape of the internal container and the support structure associated with coupling the internal container to the dispensing mechanism.

Other aspects and advantages of the present unit will become apparent from the following detailed description taken in conjunction with the accompanying drawings.

### DESCRIPTION OF THE DRAWINGS

FIG. 1 is a perspective view of one embodiment of the present beverage cooling and dispensing unit constructed in accordance with the teachings of the present invention.

FIG. 2 is an exploded perspective view of the cooler unit, internal container and lid member associated with the beverage cooling and dispensing unit of FIG. 1.

FIG. 3 is a perspective view of the internal container of the beverage cooling and dispensing unit of FIG. 2.

FIG. 4 is a top perspective view looking down into the cooler unit of FIGS. 1-3.

FIG. 5 is an enlarged partial perspective view looking down into the cooler unit of FIG. 4.

FIG. 6 is a bottom perspective view showing the drain means associated with the beverage cooling and dispensing unit of FIGS. 1-5.

FIG. 7 is a perspective view of the internal container of FIGS. 2 and 3 engaged with the present dispensing mechanism with the cooler unit removed from view.

FIG. 8 is a cross-section view of the coupling means and spring-loaded valve mechanism associated with the internal container of FIGS. 2, 3 and 7.

FIG. 9 is a top perspective view looking down into the internal container of FIGS. 2, 3 and 7 with the valve mechanism removed.

FIG. 10 is a top perspective view looking down into the internal container of FIGS. 2, 3 and 7 showing the valve mechanism in its closed position.

FIG. 11 is a partial cut-away cross-sectional view showing the internal container of FIGS. 2, 3 and 7 positioned within the cooler unit and coupled to the dispensing mechanism.

FIG. 12 is an exploded perspective view of another embodiment of the present beverage cooling and dispensing unit constructed in accordance with the teachings of the present invention.

FIG. 13 is a perspective view of the internal container of the beverage cooling and dispensing unit of FIG. 12.

FIG. 14 is a top perspective view looking down into the cooler unit of FIG. 12.

FIG. 15 is a partial cut-away cross-sectional view showing the internal container of FIGS. 12 and 13 positioned within the cooler unit of FIGS. 12 and 14 and coupled to the present dispensing mechanism.

### DETAILED DESCRIPTION OF THE PREFERRED EMBODIMENT

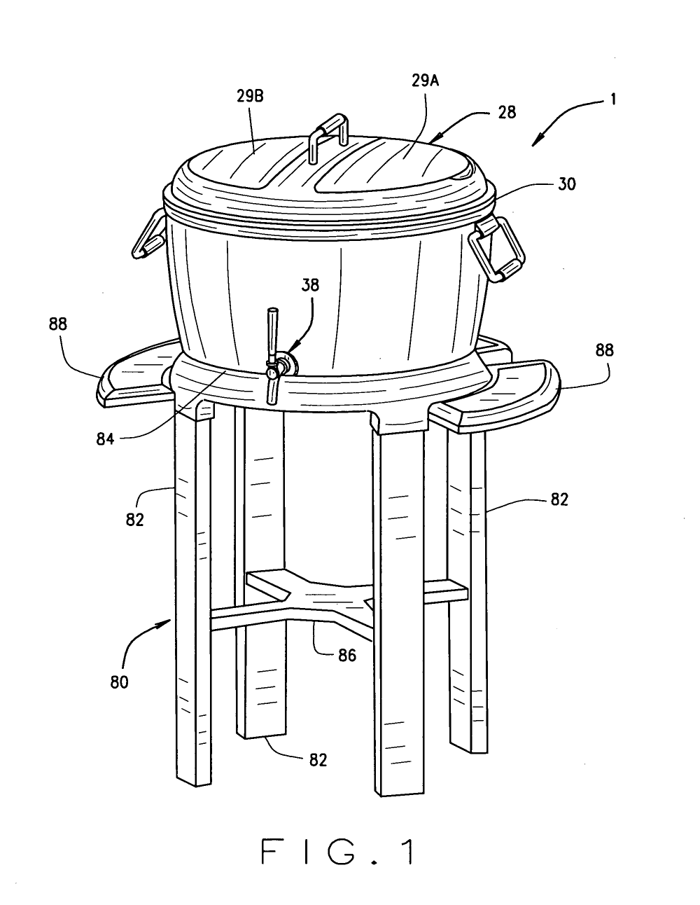

Referring to the drawings more particularly by reference numbers wherein like numbers refer to like parts, the numbers 1, 2 and 3 in FIGS. 1-11 identify a beverage cooling and dispensing unit constructed according to the teachings of one embodiment of the present invention. The beverage unit 1 includes an internal container 2 for holding a free-standing liquid, a main cooler unit 3 for housing the internal container 2 and additional items such as ice, containerized beverages, and food products, and a dispensing mechanism 38 for dispensing the free-standing liquid housed within the internal container 2. As used herein, a “free-flowing or free-standing liquid” is intended to mean any liquid that may be contained within the internal container 2 and not separately packaged in another container such as a can or bottle.

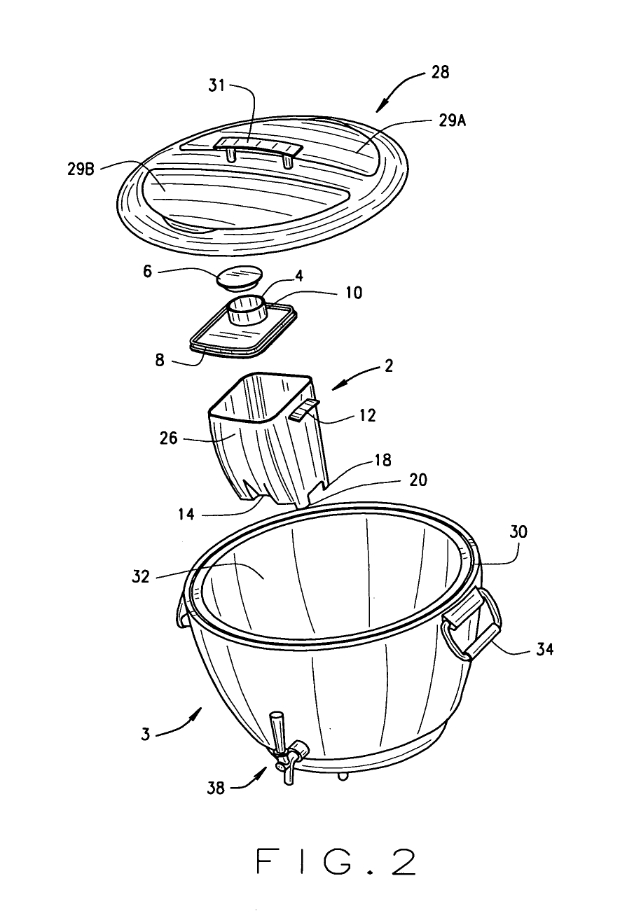

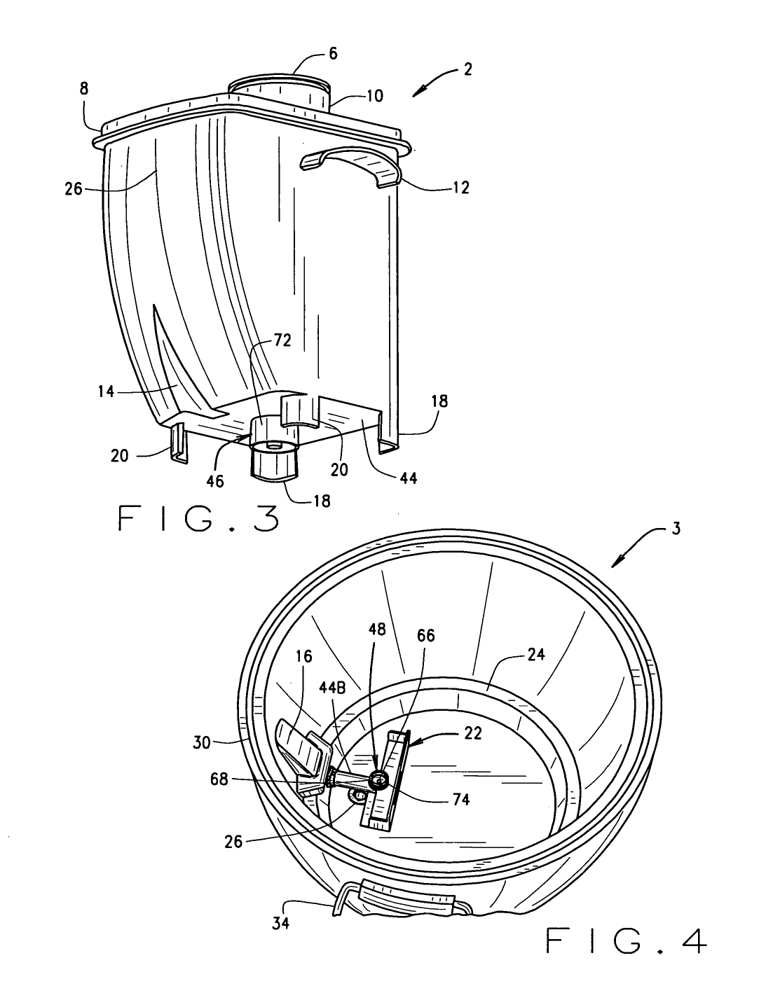

Referring to FIGS. 2 and 3, one embodiment of the internal container 2 is shown as being substantially square or rectangular in overall shape and includes an access opening or input fill opening 4 located on the upper portion 8 thereof. The access opening 4 provides access to the interior of the internal container 2 so that a user may pour or otherwise add the free-standing beverage of their choice into the interior of the internal container 2. Preferably, the internal container 2 includes a removable lid member 6 which closes off the input fill access opening 4. The removable lid member 6 preferably includes a vacuum release hole (not shown) or other means that allows the interior of the internal container to vent air in order to prevent a vacuum from forming within the internal container 2 as the liquid is drawn out. The entire upper portion 8 of the container 2 may also be removable thereby forming a larger removable lid or cover so that a user may gain better access to the interior of the internal container 2 in order to add larger items, such as fruit, or to better clean the interior of the container. Some embodiments may also include an access tube or shaft 10 defining the access opening 4, this input fill tube 10 making it easier for a user to add liquid to the internal container even while it is positioned within the main cooler unit 3 and underneath ice since the tube or shaft 10 allows the access opening 4 to protrude above the ice level.

The internal container 2 may be of any shape or size to fit easily within the cooler unit 3 with enough space left over in the interior of the cooler unit 3 for cooling means such as ice and for storing and cooling other containerized beverages such as canned or bottled beverages, juice boxes, food items, or any other product a user may want to keep chilled. Any shape for the internal container 2 which is compatible for fitting within the main cooler unit 3 is within the scope of the present invention.

Importantly, the internal container 2 is removable from the cooler unit thereby enabling, a user to remove the internal container 2 from the cooler unit 3 in order to transport it separately. In this regard, a user may remove the container 2 to fill it with a beverage, to clean it, or to store it in a refrigerator or freezer prior to placing it in the cooler unit 3. To help users easily transport the internal container 2 to and from the cooler unit 3, one embodiment includes a pair of handle members 12, one on either side of opposed sides of the container, as best shown in FIGS. 2 and 3.

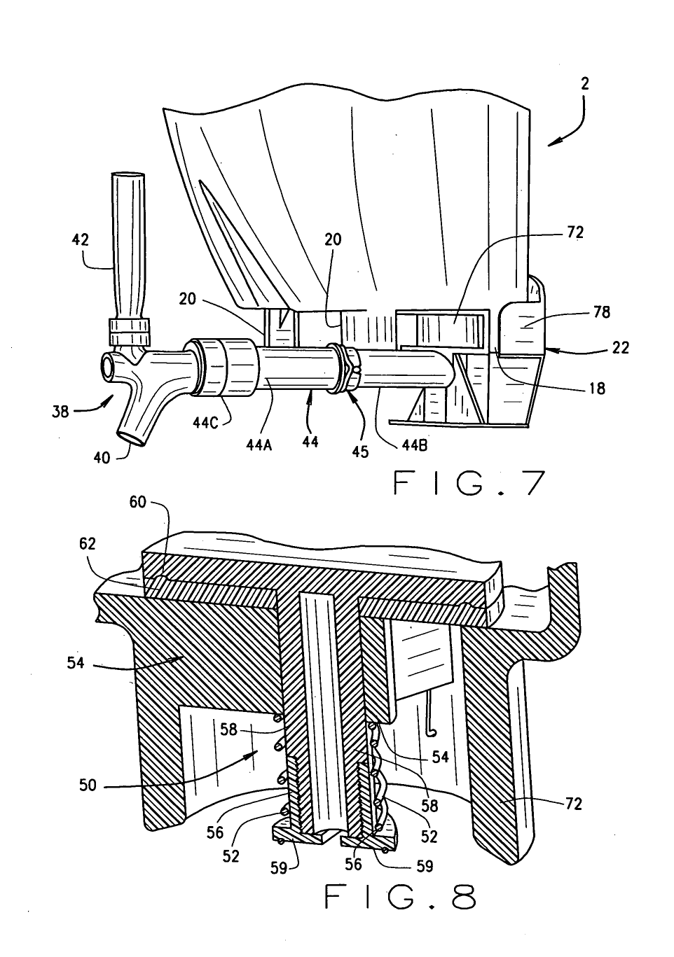

In one embodiment, the internal container 2 and cooler unit 3 include alignment means 14 and 16 as best shown in FIGS. 3-5 and 7 for facilitating and ensuring the proper positioning and alignment of the internal container 2 within the cooler unit 3 when positioned therewithin. This also ensures that the fluid coupling means 46 associated with the internal container 2 is properly engaged with the fluid coupling means 48 associated with the dispensing means 38 as will be hereinafter further explained thereby enabling fluid communication between the internal container 2 and the spout and tap mechanism 38 associated with the cooler unit 3. In the embodiment illustrated in FIGS. 2-5, the internal container 2 will only be properly coupled to the cooler unit 3 when the two alignment means 14 and 16 are cooperatively engaged in the proper orientation. If the alignment means 14 and 16 are cooperatively engaged with one another, the internal container first fluid coupling means 46 and the dispensing mechanism second fluid coupling means 48 will be in position to be removably coupled with one another. However, if alignment means 14 and 16 are not properly engaged, the two coupling means 46 and 48 will not be in a position to properly engage each other thereby preventing fluid communication between the internal container 2 and the dispensing mechanism 38. Fluid communication is accomplished through the opening of a spring loaded output check valve 50 (FIG. 8) associated with coupling means 46 of the internal container 2 as will be hereinafter further explained. The free-standing beverage in container 2 will not be dispensed from the unit 1 unless the user properly aligns the alignment means 14 and 16 and allows the coupling means 46 and 48 to properly engage each other.

In the embodiment illustrated in FIGS. 2-5 and 7, the alignment means 14 and 16 includes a recessed portion 14 associated with the side of the internal container 2 which is shaped and sized so as to be cooperatively engageable with a correspondingly shaped projection portion 16 associated with the interior of the cooler unit 3. Alternatively, the recessed portion 14 may be associated with the cooler unit 3, while the projection portion 16 may be associated with the internal container 2. Many other alignment means will be recognized by one skilled in the art and are within the scope of the present invention.

As best shown in FIGS. 2-4, one embodiment of the internal container 2 also includes leg members 18 and 20 which help to support and stabilize the internal container 2 when it is removably coupled with the cooler unit 3 and the dispensing mechanism 38. When properly positioned within the cooler unit 3, the back leg members 18 of internal container 2 rest upon the support structure 22 positioned within the cooler unit 3, while the front leg members 20 rest upon an interior shelf or ledge 24 associated with the cooler unit 3. To further stabilize and support the internal container 2 within the cooler unit 3, the front wall portion 26 (FIG. 3) of internal container 2 may likewise be shaped so as to rest upon the interior wall of the cooler unit 3 as best shown in FIG. 11. In the embodiment shown in FIGS. 3 and 11, wall portion 26 has a curved shape which corresponds to the curvature of the interior wall of the cooler unit 3.

The cooler unit 3 is shaped and sized so as to contain the internal container unit 2 as well as ice or other cooling means, and additional items such as containerized beverages and food items. Preferably, the cooler unit 3 is substantially cylindrically or annularly shaped as shown in FIGS. 1 and 2. However, as with the internal container 2, the cooler unit 3 may likewise take on any other shape so long as the internal container 2 can be properly coupled with cooler unit 3 to achieve fluid communication with the spout and tap mechanism.

As best illustrated in FIGS. 4-6, the cooler unit 3 may also include a drain means 26 for allowing a user to drain the melted ice or other liquids from the interior of the cooler unit 3. The drain means 26 can be any hole or opening in the bottom or lower side portion of the cooler unit 3. Preferably, the drain means 26 includes a removable plug 28 (FIG. 6) that the user can remove in order to open the drain means 26. Alternatively, the drain means 26 may include a valve or spigot that the user can open and close.

As best shown in FIGS. 1 and 2, the cooler unit 3 may include a lid member 28 that can be removably attached to or positioned on top of the upper rim 30 in order to close off the cooler access opening 32. By closing the cooler opening 32, the temperature within the cooler unit 3 can be maintained at a low temperature for a longer period of time. The lid member 28 may also include a pair of hinged doors 29A and 29B for providing segmented access to either side of the cooler unit 3 and a handle member 31 to allow easier handling of the lid member 28. Still further, the cooler unit 3 may also include at least two handle members 34 located on the exterior thereof to allow a user to more easily handle, maneuver and move the entire cooler unit 3 from one location to another. The handle members 34 should be strong enough to withstand the weight of the cooler unit 3, which could be significant when the cooler unit 3 is full with ice and contains a fully filled internal container 2 and other containerized products.

The cooler unit 3 also includes liquid dispensing means 38 for dispensing the free-standing liquid or beverage contained within the internal container unit 2. In the embodiment illustrated in FIGS. 1, 2, 6 and 7, the liquid dispensing means 38 includes a spout and tap mechanism which further includes a spout 40 and a tap lever member 42 that is connected to a conventional tap valve (not shown) that opens and closes the conduit 44, thereby regulating the flow of liquid from the internal container 2. When a user wishes to dispense the free-standing beverage from the internal container 2, the user simply pulls or pushes on the tap lever member 42 which opens the conventional tap valve and allows liquid to flow freely from the internal container 2, through the conduit 44, and out the spout 40. FIG. 7 shows the spout and tap mechanism 38 operatively connected to the internal container 2 with the surrounding structure of the cooler unit 3 removed from the drawing for clarity purposes only, thereby placing the interior of the internal container 2 in fluid communication with the dispensing means 38.

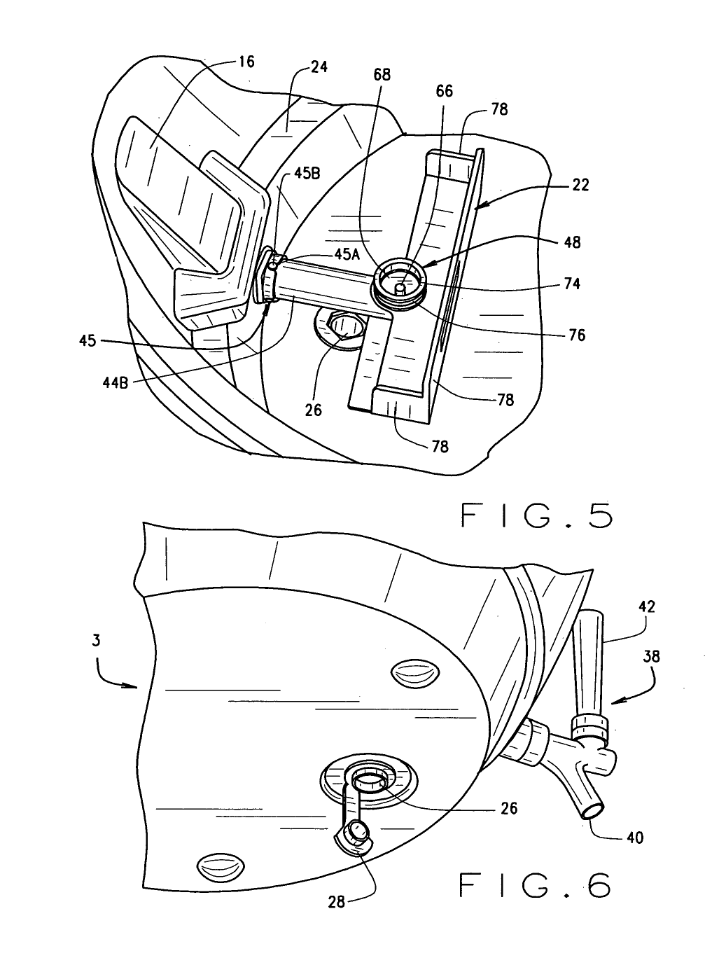

In one embodiment, as best shown in FIGS. 4, 5 and 7, the conduit 44 may be constructed into two separate sections 44A and 44B (FIG. 7) with cooperatively engageable connection means 45 positioned between the mating portions of conduits 44A and 44B. Such cooperatively engageable means 45 may include a collar member having a plurality of circumferentially spaced slots 45A associated with one end portion thereof for cooperatively receiving a corresponding plurality of circumferentially spaced projections 45B associated with the terminal end of conduit 44B as best shown in FIG. 5. The opposite end portion of the connection means 45 may be threaded for threadingly engaging the mating portion of conduit 44A. The spout and tap section may likewise be removably threadedly engageable to the opposite end of conduit 44A as at 44C for removing the spout and tap assembly during transportation. Other cooperatively engageable means may likewise be used. Use of the cooperatively engageable means 45 enables a user to removably attach the spout and tap mechanism 38 to the main cooler unit 3 and to the internal container 2 as desired to prevent damage to the dispensing means 38 when the main cooler unit 3 is being transported from one location to another. Dismantling of the dispensing means 38 also facilitates cleaning of the respective members. Although the spout and tap mechanism 38 is disclosed as one method for dispensing the non-containerized beverage from internal container 2, it is recognized and anticipated that other dispensing means may be utilized without departing from the spirit and scope of the present invention. For example, instead of using a lever member 42 to open and close the tap valve, a button-like member may be used to open and close such valve. Many other dispensing means will be recognized by one skilled in the art.

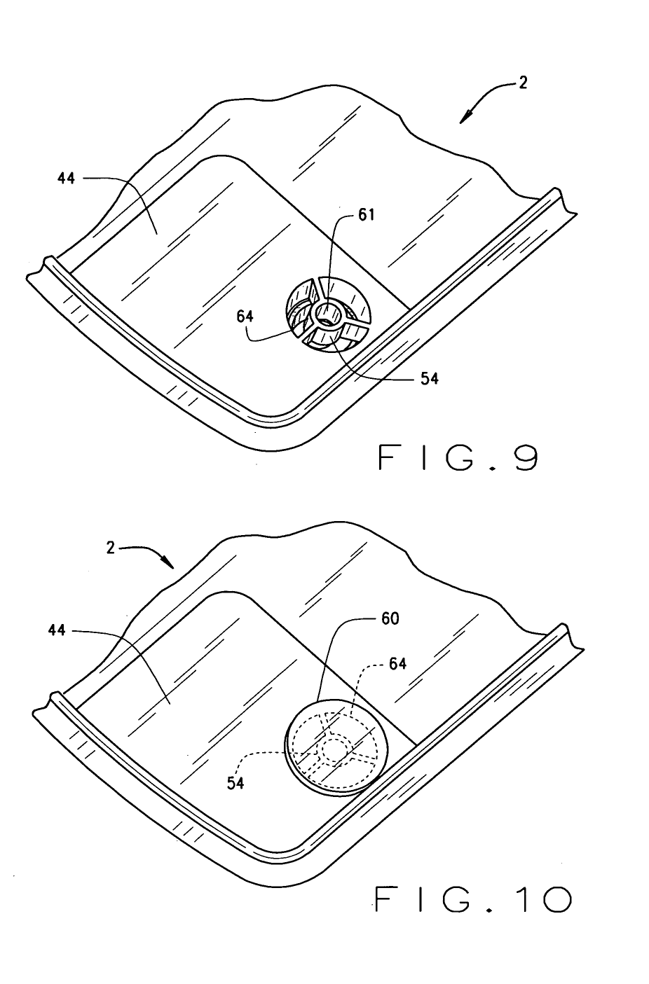

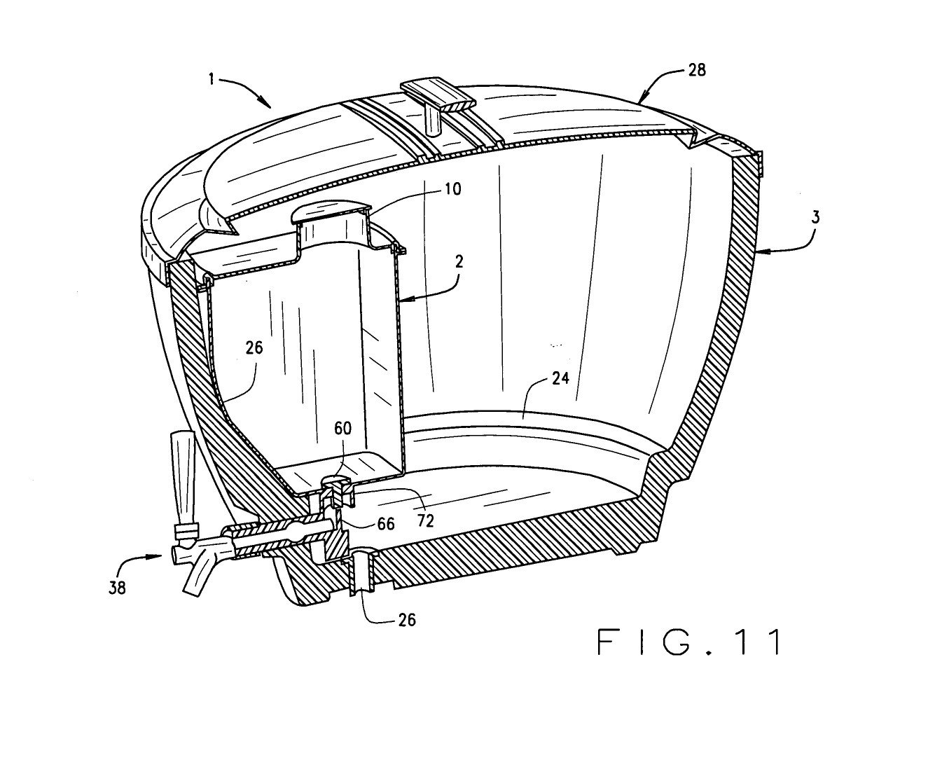

As best shown in FIGS. 3-5, the bottom portion 44 of the internal container 2 includes a first fluid coupling means 46 which is designed to removably couple with a second fluid coupling means 48 associated with conduit 44B of the dispensing mechanism 38 (FIGS. 4 and 5). FIG. 8 shows a cross-sectional view of the first coupling means 46 which includes a spring-loaded output valve 50. Spring-loaded valve 50 includes a spring member 52, a piston-holding member 54 which is preferably integrally associated with the bottom of the internal container 2 (as shown in FIG. 9 with stopper member 60 removed), a stopper member 60 that is integrally associated with a piston member 58, a washer 62 that is associated with the stopper member 60, and a piston bottom member 56 that may be screwed or otherwise attached to the bottom of the piston member 58. When the internal container 2 is not removably coupled to the dispensing mechanism 38 within the cooler unit 3, the internal container output valve 50 is in its closed position as shown in FIG. 7 with the stopper member 60 in sealed mating engagement with the interior floor surface 44 of the internal container 2 as further illustrated in FIG. 10. Referring to FIG. 8, one end portion of spring member 52 is biased against piston-holding member 54, while its opposite end portion is biased against the flange 59 located on the piston bottom member 56. The spring member 52 provides a constantly biasing downward force against the flange 59, which pulls the piston member 58 downwardly, thus pulling the stopper member 60 down as well into engagement with the interior floor surface of the internal container 2. The stopper member 60 is preferably integrally formed with the piston member 58, but may also be otherwise attached thereto. The stopper member 60 with the washer 62 associated therewith provides a fluid tight seal around the exit hole 64 of the internal container 2. The washer 62 may be rubber or another material that will provide a seal between the stopper member 60 and the exit hole 64. When the valve 50 is in its normally closed position as shown in FIGS. 8 and 10, the free-standing beverage stored within internal container 2 will not be able to exit the container 2 through the exit hole 64. This means that when the internal container 2 is removed from the main cooler unit 3, the internal container 2 can be filled at a location remote from the cooler unit 3 and can be transported to and from the cooler unit 3 without the beverage leaking from the container 2.

To open the valve 50, the stopper member 60 must be driven upwardly thereby providing a gap between the washer 62 and the exit hole 64, thus allowing the free-standing beverage to exit through the gap and through the hole 64. To effectuate the opening of the valve 50 when the internal container 2 and the cooler unit 3 are removably coupled together, a male pin, protrusion or projection 66 (shown in FIGS. 4 and 5) is utilized to provide an upward force against the piston bottom member 56. The pin 66 is preferably located near the center of entry hole 68 which is associated with the coupling means 48 located at the terminal end portion of conduit 44B. The coupling means 48 is located near the bottom of the interior of the cooler unit 3 and can be supported by the support structure 22 as best shown in FIG. 5. As the internal container 2 is placed within the cooler unit 3 and the alignment means 14 and 16 are coupled together, the piston bottom member 56 is forced against the pin or protrusion 66 of coupling means 48. Since the pin 66 is fixed and immovable, when coupling means 48 is engaged with coupling means 46, the piston member 58 is driven upward by the force applied thereagainst by the pin 66, which force compresses the spring member 52 and drives the stopper member 60 upwardly and away from exit hole 64. A gap is then created between the washer 62 and the exit hole 64 thereby allowing the non-containerized beverage to flow through the exit hole 64 and into the entry hole 68 associated with coupling means 48. From there, the beverage or liquid can flow through the coupling means 48, around pin 66, and through conduits 44B and 44A to the tap 42 and spout 40. Tap 42 controls a conventional tap valve (not shown) within conduit 44 or adjacent thereto to control the flow of the free-standing beverage through the spout 40. In the coupled position, the annularly shaped wall 72 (FIGS. 3 and 7) encircling the first coupling means 46 surrounds the annularly shaped wall 74 encircling the second coupling means 48 (FIG. 5). A seal is formed between the two annularly shaped walls 72 and 74 by one or more sealing rings 76 that encircle wall 74. These sealing rings 76 provide a substantially sealed connection between coupling means 46 and 48 so that the beverage or liquid will not leak out therebetween.

In the embodiment shown in FIG. 8, the piston bottom member 56 can be threadably removed from the piston member 58, similar to a threaded fastener, in order to easily assemble the valve 50. This allows the piston member 58 to be slidably received within the opening or hole 61 (FIG. 9) associated with the piston holding member 54. Because piston bottom member 56 includes the flange 59, which is larger in diameter than hole 61, the piston member 58 would not otherwise be insertable through hole 61 except for the separability of piston bottom member 56. Once piston member 58 is inserted into piston holding member 54, spring member 52 is placed around piston member 58 and piston bottom member 56 is then threadedly secured to the bottom member, thus trapping spring member 52 between the piston holding member 54 and flange 59.

The interaction between coupling means 46 and 48 described above is merely one example of providing output valve means which achieves a tight fluid seal when the internal container 2 is removed from the cooler unit 3 and which provides fluid communication therebetween when engaged in operative position. It is recognized and anticipated that a wide variety of valves and coupling means could be used to achieve the stated objectives. One skilled in the art would be knowledgeable of the many different types of other valves and coupling means available in the art, including equivalent structures, which could be used without departing from the spirit and scope of the present invention.

The embodiment of the internal container 2 shown in FIGS. 2, 3 and 7 is supported and stabilized in its removably coupled position within the cooler unit 3 by several coordinating mechanisms. First, the interaction between the internal container first coupling means 46 and the dispensing mechanism second coupling means 48 provides some stability. Second, the back leg members 18 of the internal container 2 rest upon and are stabilized by the walls 78 of the support structure 22 as best shown in FIG. 7. Third, the front leg members 20 of the internal container 2 rest upon the shelf or ledge 24 of the cooler unit 3. Finally, the front portion 26 of internal container 2 rests upon the interior wall of the cooler unit 3. All of these mechanisms contribute to supporting the internal container 2 within the main cooler unit 3 when properly engaged therewith, although other means for supporting the internal container 2 are recognized and anticipated.

To facilitate easier dispensing of the beverage or liquid contained within the internal container 2, the overall assembly may include a support stand 80 for elevating the assembly 1 above the ground as shown in FIG. 1. The stand 80 makes it easier and facilitates dispensing of the non-containerized beverage from the spout and tap mechanism 38, and for accessing the interior of the cooling unit 3. The support stand 80 includes a plurality of leg members 82 mounted to a support shelf or platform 84 adapted for holding and supporting the cooler unit 3 thereon. The stand 80 may further include additional supporting structure 86 which provides additional structural support and stability for the leg members 82. The platform 84 may further include one or more side shelves such as the shelf members 88, which provide additional surface area for placing cups, drinks, containerized beverages, food items and the like thereon.

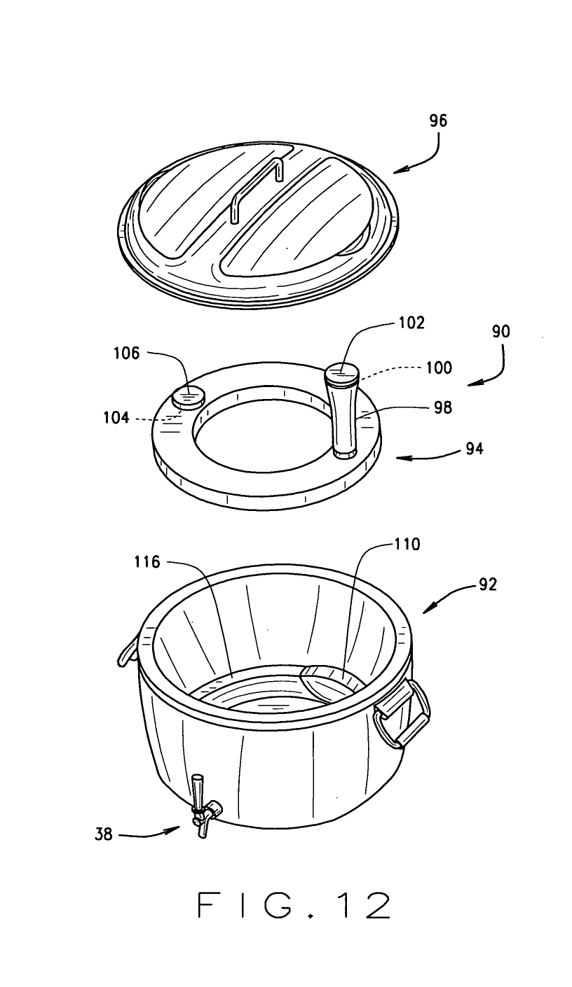

FIGS. 12-15 illustrate an alternative embodiment 90 of a beverage cooling and dispensing unit constructed according to the teachings of the present invention. The embodiment 90 includes a main cooler unit 92, an internal container 94, and a lid member 96. Embodiment 90 differs from the assembly 1 illustrated in FIGS. 1-11 primarily with respect to the construction and shape of the internal container 94 which is substantially annular in shape. Embodiment 90 also differs from the embodiment disclosed in FIGS. 1-11 with respect to the cooperatively engageable alignment means associated with the internal container 2 and the main cooler unit 3 as well as with the support structure 22 illustrated in FIGS. 4 and 5. In all other respects, embodiment 90 is substantially similar in construction and operation with respect to embodiment 1 as will be hereinafter explained.

More particularly, internal container 94 is substantially annularly shaped as illustrated in FIGS. 12, 13 and 15 and, like internal container 2, includes an access fill tube or shaft 98 defining an inlet or access fill opening 100 for easily filling the container 94 with a non-containerized beverage. A removable lid member 102 closes off the access opening 100 and may likewise include a vacuum release hole (not shown) for the reasons set forth above with respect to internal container 2. Still further, internal container 94 includes a second, preferably larger, opening 104 with an associated removable cap member 106 for providing greater access to the internal container 94 so as to add larger items, such as fruit, to the non-containerized beverage, or to better clean the interior of the container 94.

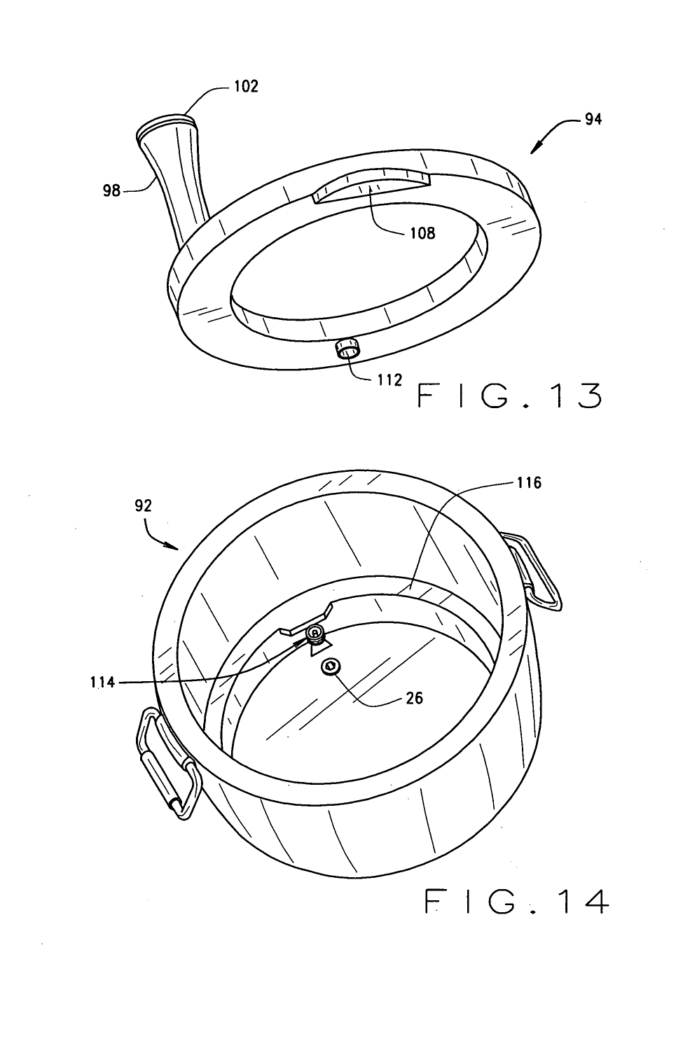

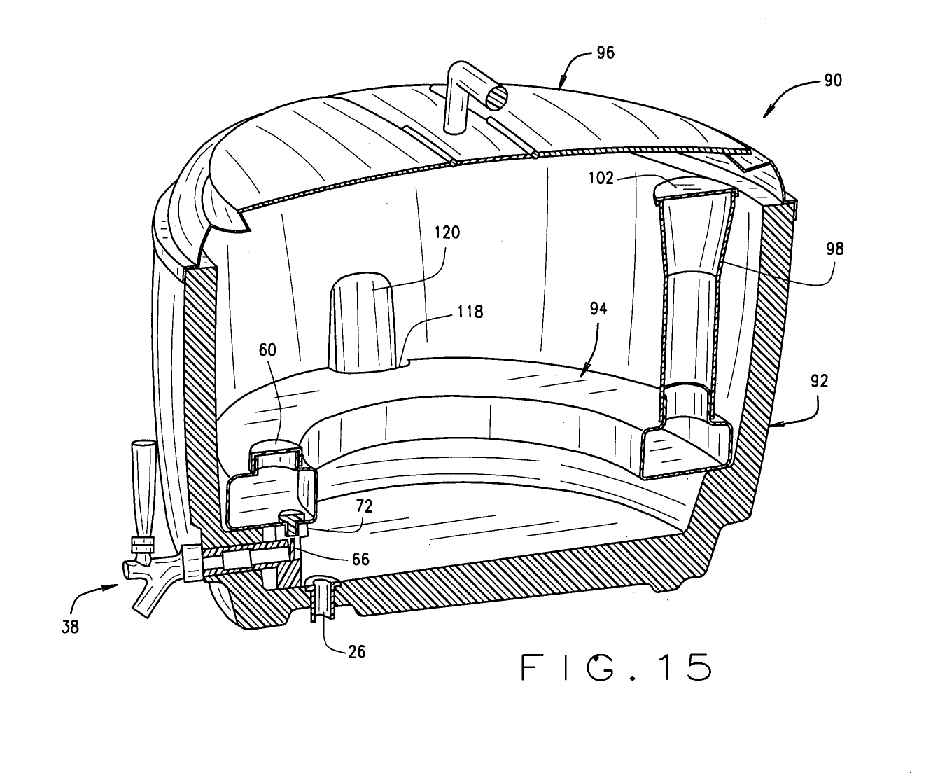

Like internal container 2, internal container 94 includes alignment means 108 (FIG. 12) in the form of a recessed cavity associated with the bottom portion of internal container 94 which correspondingly mates with a raised projection or shoulder 110 (FIG. 12) associated with the main cooler unit 92. Alignment means 108 and 110 function in substantially the same manner as alignment means 14 and 16 discussed above and ensure proper positioning and alignment of the internal container 94 within the cooler unit 92 when positioned therewithin. As explained above, this ensures proper fluid communication between the internal container 94 and the dispensing means 38 when the members 92 and 94 are cooperatively coupled and engaged with each other as previously explained. In this regard, internal container 94 includes fluid coupling means 112 (FIG. 13) which is positioned and located so as to cooperatively engage the fluid coupling means 114 (FIG. 14) associated with dispensing means. As previously explained with respect to alignment means 14 and 16 and coupling means 46 and 48, when the recessed alignment cavity 108 associated with internal container 94 is properly positioned and engaged with the correspondingly shaped alignment projection 110 associated with cooler unit 92, coupling means 112 and 114 will be properly aligned for engagement with each other as previously explained so as to enable fluid communication between the internal container 94 and the spout and tap mechanism 38. Importantly, the construction and operation of coupling means 112 and 114 are substantially identical to the construction and operation of the coupling means 46 and 48 including the operation of the valve mechanism 50 associated with the internal container 94 and its corresponding pin or projection 66 associated with coupling means 114. Engagement of the coupling means 112 and 114 is illustrated in FIG. 15.

Also, importantly, the shape and construction of internal container 94 is such that it can be positioned and located so as to rest upon the circumferential ledge 116 associated with the main cooler unit 92 as illustrated in FIG. 12. Ledge 116 is comparable to ledge 24 illustrated in FIGS. 4 and 5. As a result, since internal container 94 rests and is supported by ledge 116, the additional support structure 22 associated with main cooler unit 3 as illustrated in FIGS. 4 and 5 is not necessary since ledge 116 will substantially support the weight of the non-containerized beverage stored within internal container 94 at all locations around its perimeter. Except for the elimination of the support structure 22, the dispensing means 38 including the construction and operation of the spout and tap mechanism 40 and 42 and the conduits 44A and 44B are all substantially identical to the construction and operation previously discussed above.

Still further, it is important to note that the fill tube or fill shaft 98 associated with internal container 94 is substantially longer in length as compared to the fill tube 10 associated with internal container 2. This is because internal container 94 is positioned and located towards the bottom of the main cooler unit 92 and the extended fill tube 98 is designed to provide access to the fill opening 100 near the top of the cooler unit 92 as best illustrated in FIG. 15. This provides easy access to the fill opening 100 of internal container 94 when the cooler unit 92 is filled with ice and other containerized beverages.

Also, importantly, it should be noted that FIG. 15 illustrates another alignment means, different from alignment means 108 and 110, for properly positioning internal container 94 within cooler unit 92. As illustrated in FIG. 15, such alignment means may alternatively include a slot or notch 118 associated with the outer periphery of the internal container 94 for mating with a corresponding projection or protrusion 120 associated with the interior wall portion of cooler unit 92. In all other respects, the cooler unit 92, internal container 94, and lid member 96 are constructed and operate substantially similarly to the internal container 2, the cooler unit 3, and the lid member 28.

It is recognized that the overall dimensions of the present assemblies as well as the specific shape and configuration of the various members associated therewith are all subject to wide variations and may be sized and shaped into a wide variety of different sizes and configurations without impairing the teachings and practice of the present invention. Although the cooler units 3 and 92 are illustrated as being substantially cylindrical in shape, such members can likewise take on other shapes such as square, triangular, rectangular, and so forth. The same is likewise true with respect to the size and shape of the internal containers 2 and 94 as explained above. It is also recognized and anticipated that the second coupling means 48 and 114 could be associated with the cooler units 3 and 92 and the dispensing mechanism 38 may merely engage the second coupling means. Other variations and modifications to the various components comprising the present structures are also contemplated and envisioned.

Thus, there has been shown and described several embodiments of a novel beverage cooling and dispensing unit which fulfills all of the objects and advantages sought therefor. Many changes, modifications, variations and other uses and applications of the present invention will, however, become apparent to those skilled in the art after considering this specification and the accompanying drawings. All such drawings, modifications, variations and other uses and applications which do not depart from the spirit and scope of the present invention are deemed to be covered by the present invention which is limited only by the claims which follow.

1. A beverage cooling and dispensing unit comprising:
a cooler member adaptable for holding and cooling containerized products;
an internal container adaptable for holding non-containerized beverages, said internal container being removably positionable within said cooler member and having first coupling means associated therewith for controlling the flow of the non-containerized beverage out of said internal container; and
dispensing means accessible from the exterior of said cooler member for dispensing the non-containerized beverage from said internal container when said internal container is positioned within said cooler member, said dispensing means extending into the interior of said cooler member and including second coupling means removably engageable with said first coupling means, said dispensing means being in fluid communication with said internal container when said first and second coupling means are engaged.

2. The beverage cooling and dispensing unit defined in claim 1 including alignment means associated with said cooler member and said internal container for ensuring proper positioning of said internal container within said cooler member when positioned therewithin.

3. The beverage cooling and dispensing unit defined in claim 2 wherein said alignment means includes a recessed portion associated with said internal container and a protruding portion associated with said cooler member, said protruding portion being cooperatively receivable within said recessed portion.

4. The beverage cooling and dispensing unit defined in claim 2 wherein said alignment means further ensures proper positioning of said first and second coupling means relative to each other for engagement therewith when said internal container is positioned within said cooler member.

5. The beverage cooling and dispensing unit defined in claim 1 wherein said first coupling means includes a valve mechanism, said valve mechanism being movable between a closed position and an open position, said valve mechanism being in a closed position preventing the non-containerized beverage from flowing out of said internal container when said internal container is disengaged from said second coupling means, said valve mechanism being in its open position allowing the non-containerized beverage to flow out of said internal container when said first coupling means is engaged with said second coupling means.

6. The beverage cooling and dispensing unit defined in claim 5 wherein said valve mechanism is biased to its closed position.

7. The beverage cooling and dispensing unit defined in claim 5 wherein said second coupling means includes a pin member engageable with the valve mechanism associated with said first coupling means, said pin member moving said valve mechanism to its open position when said first and second coupling means are engaged.

8. The beverage cooling and dispensing unit defined in claim 5 wherein said first coupling means further includes an annularly shaped wall that encircles said valve mechanism, said annularly shaped wall being sized and dimensioned so as to receive said second coupling means.

9. The beverage cooling and dispensing unit defined in claim 7 wherein said second coupling means further includes an annularly shaped wall that encircles said pin member, said annularly shaped wall being sized and dimensioned so as to be insertably receivable within said first coupling means.

10. The beverage cooling and dispensing unit defined in claim 1 wherein said first coupling means includes a spring loaded valve member, said valve member being biased to a closed position when said first coupling means is disengaged from said second coupling means, and said valve member being moved to an open position when said first coupling means is engaged with said second coupling means.

11. The beverage cooling and dispensing unit defined in claim 1 wherein said first coupling means includes:
a spring loaded valve device; and
an annularly shaped wall that encircles said spring loaded valve device, said annularly shaped wall being sized and dimensioned so as to cooperatively receive said second coupling means.

12. The beverage cooling and dispensing unit defined in claim 1 wherein said second coupling means includes an annularly shaped wall and at least one seal ring which encircles said annularly shaped wall, said annularly shaped wall being sized and dimensioned so as to be insertably received within said first coupling means so as to form a seal between said at least one seal ring and said first coupling means.

13. The beverage cooling and dispensing unit defined in claim I further including support means located within said cooler member for supporting said internal container in its operative position therewithin.

14. The beverage cooling and dispensing unit defined in claim 1 further including drain means associated with said cooler member.

15. The beverage cooling and dispensing unit defined in claim 1 further including a lid member positionable on said cooler member for providing access to the interior thereof.

16. The beverage cooling and dispensing unit defined in claim 1 wherein said internal container includes an inlet opening for filling said container with a non-containerized beverage.

17. The beverage cooling and dispensing unit defined in claim 16 wherein said inlet opening is defined by an inlet fill tube which extends to a position near the top portion of said cooler member when said internal container is operatively positioned therewithin.

18. The beverage cooling and dispensing unit defined in claim 1 wherein said dispensing means includes a spout and tap mechanism.

19. The beverage cooling and dispensing unit defined in claim 1 further including a support stand for holding and supporting said cooler member.

20. A beverage and cooling dispensing apparatus for holding both containerized and non-containerized beverages comprising:
an internal container for holding non-containerized beverages, said internal container including an access opening for filling the container with a non-containerized beverage and an output flow valve for controlling the flow of the non-containerized beverage out of said internal container, said output valve being in a normally closed position;
a cooler unit for holding and cooling said internal container along with other containerized beverages; and
a dispensing mechanism accessible from the exterior of said cooler unit and in fluid communication with said internal container for dispensing the non-containerized beverage stored therewithin when said internal container is positioned within said cooler unit, said dispensing mechanism extending into the interior of said cooler unit and including a coupling member for cooperatively engaging said output valve, said coupling member moving said output valve to an open position when said coupling member is cooperatively engaged with said output valve.

21. The beverage cooling and dispensing apparatus defined in claim 20 wherein said internal container includes a recessed portion adaptable for cooperatively receiving a projection associated with said cooler unit when said internal container is operatively positioned within said cooler unit.

22. The beverage cooling and dispensing apparatus defined in claim 20 wherein said output valve includes biasing means normally biasing said valve to its closed position when said internal container is removed from said cooler unit.

23. The beverage cooling and dispensing apparatus defined in claim 20 wherein said coupling member includes a pin member positioned and located so as to move said output valve to its open position when said coupling member is cooperatively engaged therewith.

24. The beverage cooling and dispensing apparatus defined in claim 20 wherein said internal container is substantially annular in shape, and wherein said cooler unit includes a ledge portion positioned and located for supporting said internal container when positioned therewithin.

25. The beverage cooling and dispensing apparatus defined in claim 20 wherein said cooler unit includes means for draining any accumulated liquid formed therein.

26. The beverage cooling and dispensing apparatus defined in claim 20 wherein said cooler unit includes a lid member, said lid member being movable to provide access to the interior of said cooler unit.

27. The beverage cooling and dispensing apparatus defined in claim 20 wherein said internal container includes a removable cap for closing the access opening.

29. The beverage cooling and dispensing apparatus defined in claim 27 wherein said removable cap includes venting means for preventing a vacuum from developing within said internal container.

30. The beverage cooling and dispensing apparatus defined in claim 20 wherein said dispensing mechanism is removable from said cooler unit.

31. The beverage cooling and dispensing apparatus defined in claim 20 wherein said internal container includes a notch adaptable for cooperatively mating with a corresponding projection associated with the interior wall portion of said cooler unit.

32. A beverage cooling and dispensing unit comprising:
a cooler member adaptable for holding and cooling containerized products;
an internal container adaptable for holding non-containerized beverages, said internal container being removably positionable within said cooler member and having a first coupling member associated therewith; and
a dispensing mechanism accessible from the exterior of said cooler member for dispensing the non-containerized beverage from said internal container, said dispensing mechanism extending into the interior of said cooler member and including a second coupling member engageable with said first coupling member, said dispensing mechanism being in fluid communication with said internal container when said first and second coupling members are engaged;
said first coupling member preventing the flow of the non-containerized beverage out of said internal container when disengaged from said second coupling member, said first coupling member allowing the non-containerized beverage to flow out of said internal container when engaged with said second coupling member.

33. A beverage cooling and dispensing apparatus comprising:
an internal container for holding a free-standing liquid, said internal container having a first access opening for filling the container with the free-standing liquid and having a second opening for allowing the free-standing liquid to exit said internal container;
a cooler unit for holding and cooling said internal container when positioned therewithin, said cooler unit having additional space for holding and cooling other products;
a spring biased valve member positionable within the second opening of said internal container, said valve member being positionable between a closed position wherein said second opening is sealed so as to prevent the free-standing liquid from exiting said internal container and an open position wherein the free-standing liquid is allowed to exit said internal container, said valve mechanism being biased to its closed position;
a coupling member adaptable for cooperatively engaging said spring biased valve member, said coupling member moving said valve member to its open position when engaged therewith; and
a dispensing mechanism accessible from the exterior of said cooler unit for dispensing the free-standing liquid through said valve member, said dispensing mechanism extending into the interior of said cooler unit and being engageable with said coupling member, said free-standing liquid being dispensable from said internal container when said coupling member is engaged with said valve member and said dispensing mechanism is engaged with said coupling member.

34. The beverage cooling and dispensing apparatus defined in claim 33 wherein said coupling member is associated with said cooler unit.

35. The beverage cooling and dispensing apparatus defined in claim 33 wherein said coupling member is associated with said dispensing mechanism.
